(19) United States
(12) Patent Application Publication
(10) Pub. No.: US 2026/0044177 A1
(43) Pub. Date: Feb. 12, 2026

(54) EMBEDDED SYSTEM AND POWER SAVING CONTROL METHOD THEREOF

(71) Applicant: REALTEK SEMICONDUCTOR CORPORATION, HSINCHU (TW)

(72) Inventors: YI-MING HSU, HSINCHU (TW); LUN-WU YEH, HSINCHU (TW); HSIEH-HAN CHIANG, HSINCHU (TW)

(21) Appl. No.: 19/272,446

(22) Filed: Jul. 17, 2025

(30) Foreign Application Priority Data
Aug. 9, 2024 (TW) 113130064

(51) Int. Cl. G06F 1/04

(52) U.S. Cl. CPC G06F 1/04

(57) ABSTRACT

An embedded system includes a clock controller circuit, a clock gating circuit, and a bus controller circuit. The clock controller circuit is configured to set a memory control signal according to a sleep signal from a processor to control a first memory to enter a sleep mode and to set a clock control signal and a request signal according to the sleep signal. The clock gating circuit is configured to stop transmitting a plurality of clock signals to the processor and the first memory according to the clock control signal. The bus controller circuit is configured to stop sending an access request to the processor and the first memory according to the request signal.

### BACKGROUND OF THE INVENTION

### Field of the Invention

The present disclosure relates to an embedded system, especially to an embedded system that gates clock signal(s) and supply voltage(s) and a power-saving control method thereof.

### Description of Related Art

In existing embedded systems, when an embedded system enters a power-saving mode, some clock circuits and internal memory within the system continue operating, leading to additional power consumption. For example, if a signal path in certain clock circuits is long, this signal path may still cause a certain level of power consumption even in the power-saving mode.

### SUMMARY OF THE INVENTION

In some aspects, an object of the present disclosure is to, but not limited to, provide an embedded system that gates clock signal(s) and supply voltage(s) and a power-saving control method thereof, so as to make an improvement to the prior art.

In some aspects, an embedded system includes a clock controller circuit, a clock gating circuit, and a bus controller circuit. The clock controller circuit is configured to set a memory control signal according to a sleep signal from a processor to control a first memory to enter a sleep mode and to set a clock control signal and a request signal according to the sleep signal. The clock gating circuit is configured to stop transmitting a plurality of clock signals to the processor and the first memory according to the clock control signal. The bus controller circuit is configured to stop sending an access request to the processor and the first memory according to the request signal.

In some aspects, a power-saving control method includes the following operations: setting a memory control signal according to a sleep signal from a processor to control a first memory to enter a sleep mode and setting a clock control signal and a request signal according to the sleep signal; stopping transmitting a plurality of clock signals to the processor and the first memory according to the clock control signal; and stopping sending an access request to the processor and the first memory according to the request signal.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a schematic diagram of an embedded system 100 according to some embodiments of the present disclosure.

FIG. 2A illustrates a flowchart illustrating the operations performed by the embedded system when entering the first power-saving mode according to some embodiments of the present disclosure.

FIG. 2B illustrates a flowchart illustrating the operations performed by the embedded system when exiting the first power-saving mode according to some embodiments of the present disclosure.

FIG. 3A illustrates a flowchart illustrating the operations performed by the embedded system when entering the second power-saving mode according to some embodiments of the present disclosure.

FIG. 3B illustrates a flowchart illustrating the operations performed by the embedded system when exiting the second power-saving mode according to some embodiments of the present disclosure.

FIG. 4A illustrates a flowchart illustrating the operations performed by the embedded system when entering the third power-saving mode according to some embodiments of the present disclosure.

FIG. 4B illustrates a flowchart illustrating the operations performed by the embedded system when exiting the third power-saving mode according to some embodiments of the present disclosure.

FIG. 5 illustrates a flowchart illustrating the operations performed by the processor in selecting a power-saving mode according to some embodiments of the present disclosure.

FIG. 6 illustrates a flowchart illustrating a power-saving control method according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuitry” may indicate a system implemented with at least one circuit, and the term “circuit” may indicate an object, which is formed with one or more transistors and/or one or more active/passive elements according to a specific arrangement, for processing signals.

As used herein, the term "and/or" includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, similar/identical elements in various figures are designated with the same reference number.

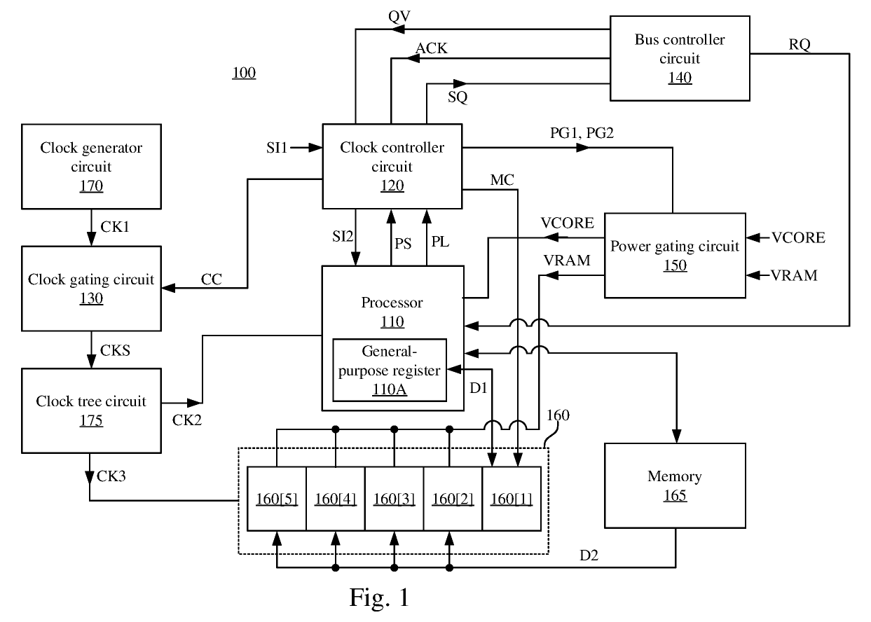

FIG. 1 illustrates a schematic diagram of an embedded system 100 according to some embodiments of the present disclosure. In different embodiments, the embedded system 100 may be applied to various electronic devices, including but not limited to, smartphones, laptop computers, and so on. The embedded system 100 includes a processor 110, a clock controller circuit 120, a clock gating circuit 130, a bus controller circuit 140, a power gating circuit 150, a memory 160, a memory 165, a clock generator circuit 170, and a clock tree circuit 175. The processor 110 is coupled to the clock controller circuit 120 and transmits a sleep signal PS to the clock controller circuit 120 when entering the wait-for-interrupt (WFI) mode (also referred to as sleep mode), such that the clock controller circuit 120 controls other circuits (such as the processor 110, the clock gating circuit 130, the bus controller circuit 140, the power gating circuit 150, and the memory 160) to enter a power-saving mode, thereby reducing overall power consumption.

The clock controller circuit 120 is configured to set a memory control signal MC according to the sleep signal PS from the processor 110 to control the memory 160 to enter the sleep mode, and to set a clock control signal CC and a request signal SQ according to the sleep signal PS. In some embodiments, the clock controller circuit 120 may include one or more registers (not shown), which may store related values of the sleep signal PS, the clock control signal CC, and the request signal SQ. The memory 160, the clock gating circuit 130, and the bus controller circuit 140 are coupled to the one or more registers and execute corresponding operations according to these signals when values of these signals are set. Alternatively, the clock controller circuit 120 may clear values of these signals in the registers, allowing the memory 160, the clock gating circuit 130, and the bus controller circuit 140 to resume original operations. In some embodiments, the clock controller circuit 120 is further configured to receive an interrupt signal S11 from other devices or circuits (not shown), generate an interrupt signal S12 according to S11, and transmit S12 to the processor 110 to wake the processor 110 from the sleep mode. In some embodiments, the bus controller circuit 140 is configured to stop sending an access requests RQ to the processor 110 and/or the memory 160 according to the request signal SQ. In some embodiments, if the access request RQ is to access a specific memory module in the memory 160, the processor 110 may forward the access request RQ to a controller (not shown) of the memory 160, allowing the controller to access the specific memory module accordingly.

In some embodiments, when the bus controller circuit 140 receives an access request from another device or circuit (not shown), the bus controller circuit 140 may issue a request validation signal QV to the clock controller circuit 120, which interacts with the bus controller circuit 140 according to a predetermined transmission interface protocol to notify the clock controller circuit 120 to wake up the processor 110. In other words, in different cases, when the clock controller circuit 120 detects the interrupt signal S11 or the request validation signal QV, the clock controller circuit 120 may issue the interrupt signal S12 to wake up the processor 110 and clear the request signal SQ. As a result, the bus controller circuit 140 may transmit an acknowledgment signal ACK to the clock controller circuit 120 and begin sending the access request RQ.

The clock generator circuit 170 operates as a clock source to provide an original clock signal CK1. The clock gating circuit 130 is coupled to the clock generator circuit 170 to receive the original clock signal CK1 and outputs original clock signal CK1 as a system clock signal CKS. The clock tree circuit 175 generates a clock signal CK2 and a clock signal CK3 according to the system clock signal CKS and transmits the clock signals CK2 and CK3 to the processor 110 and the memory 160, respectively. The clock gating circuit 130 is further configured to cause the processor 110 and the memory 160 to stop receiving the clock signals CK2 and CK3 according to the clock control signal CC. For example, after the clock controller circuit 120 sets the clock control signal CC, the clock gating circuit 130 may mask the system clock signal CKS according to the clock control signal CC, i.e., stop sending the system clock signal CKS to the clock tree circuit 175, such that the clock tree circuit 175 stops generating the clock signals CK2 and CK3. As a result, the processor 110 and the memory 160 stop receiving the clock signals CK2 and CK3, thereby reducing dynamic power consumption of the processor and the memory 160. In some embodiments, the clock gating circuit 130 may be implemented with, but not limited to, an integrated clock gating cell. In some embodiments, the clock generator circuit 170 may be implemented with, but not limited to, a phase-locked loop (PLL) circuit. In some embodiments, the clock tree circuit 175 may be implemented with, but not limited to, one or more buffers or delay circuits.

In some embodiments, the clock controller circuit 120 is further configured to set a power control signal PG1 according to the sleep signal PS, and the power gating circuit 150 is configured to stop powering the processor 110 according to the power control signal PG1. For example, the power gating circuit 150 includes a switch circuit (not shown), which is selectively turned on according to the power control signal PG1 to transmit a power voltage VCORE to the processor 110. In other words, the power control signal PG1 is utilized to determine whether to power the processor 110. In some embodiments, the clock controller circuit 120 is further configured to set a power control signal PG2 according to the sleep signal PS, and the power gating circuit 150 is configured to stop powering the memory 160 according to the power control signal PG2. For example, the power gating circuit 150 includes a switch circuit (not shown), which is selectively turned on according to the power control signal PG2 to transmit a power voltage VRAM to certain memory modules (e.g., memory modules 160[2]-160[5]) in the memory 160. In other words, the power control signal PG2 is utilized to determine whether to power these memory modules. In some embodiments, the memory 160 may be a volatile memory (which may be, but not limited to, static random-access memory), which includes a memory module 160[1] and memory modules 160[2]-160[5], in which the memory module 160[1] is powered without power gating, and the memory modules 160[2]-160[5] are powered with power gating (e.g., receiving the power voltage VRAM via the power gating circuit 150).

In some embodiments, the processor 110 may set a power-saving level signal PL via system software and/or firmware, and the clock controller circuit 120 may determine whether to set the power control signal PG1 and/or PG2 according to the power-saving level signal PL and the sleep signal PS. For example, if the embedded system 100 is applied to a laptop, when the laptop is connected to a charger (i.e., powered by an external power source), the processor 110 may set the power-saving level signal PL to a first value. Under this condition, the clock controller circuit 120 may generate the clock control signal CC and the request signal SQ according to the sleep signal PS and the power-saving level signal PL to control the clock gating circuit 130 and the bus controller circuit 140 to enter a first power-saving mode. Alternatively, when the laptop is not connected to a charger and its battery level is above a threshold, the processor 110 may set the power-saving level signal PL to a second value. Under this condition, the clock controller circuit 120 may generate the clock control signal CC, the request signal SQ, and the power control signal PG1 according to the sleep signal PS and the power-saving level signal PL to control the clock gating circuit 130, the bus controller circuit 140, and the power gating circuit 150 to enter a second power-saving mode. Furthermore, when the laptop is not connected to a charger and its battery level is below the threshold, the processor 110 may set the power-saving level signal PL to a third value. Under this condition, the clock controller circuit 120 may generate the clock control signal CC, the request signal SQ, and the power control signals PG1 and PG2 according to the sleep signal PS and the power-saving level signal PL to control the clock gating circuit 130, the bus controller circuit 140, and the power gating circuit 150 to enter a third power-saving mode.

In the first power-saving mode, the clock gating circuit 130 may stop providing the system clock signal CKS to the clock tree circuit 175, thereby ceasing transmitting the clock signals CK2 and CK3 to the processor 110 and the memory 160, in order to reduce dynamic power consumption. In the second power-saving mode, the power gating circuit 150 further stops powering the processor 110. In the third power-saving mode, the power gating circuit 150 additionally stops powering the memory modules 160[2]-160[5]. In other words, the power savings of the third power-saving mode are greater than those of the second power-saving mode or the first power-saving mode, and the power savings of the second power-saving mode are greater than those of the first power-saving mode.

For illustrative purposes, the following paragraphs describe the operations of the embedded system 100 when entering and exiting the first, second, and third power-saving modes with reference to different figures. In different embodiments, any of the circuits in the embedded system 100 may be implemented with at least one digital logic circuit, which may be configured as a state machine to execute the operations described in the following figures. However, the present disclosure is not limited to thereto.

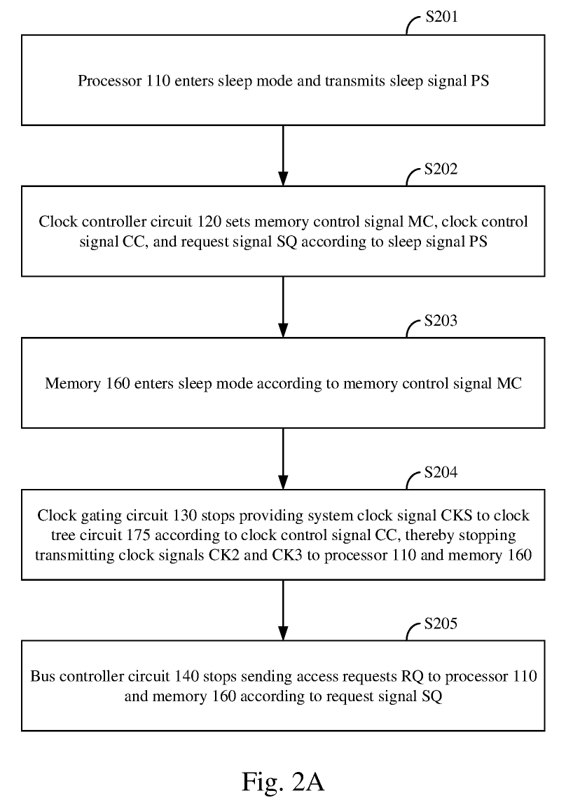

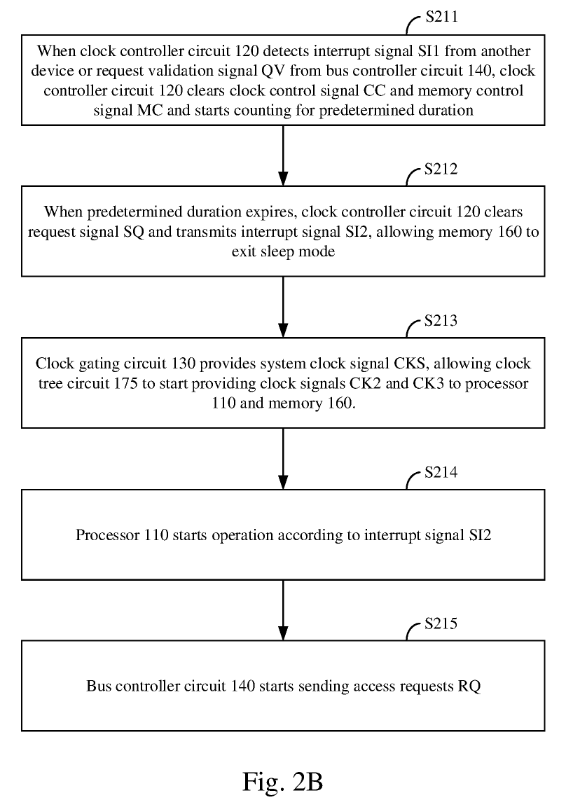

FIG. 2A illustrates a flowchart illustrating the operations performed by the embedded system 100 when entering the first power-saving mode according to some embodiments of the present disclosure. In operation S201, the processor 110 enters the sleep mode and transmits the sleep signal PS. In operation S202, the clock controller circuit 120 sets the memory control signal MC, the clock control signal CC, and the request signal SQ according to the sleep signal PS. In some embodiments, the clock controller circuit 120 may confirm that the processor 110 is in sleep mode according to the sleep signal PS. In operation S203, the memory 160 enters the sleep mode according to the memory control signal MC. In operation S204, the clock gating circuit 130 stops providing the system clock signal CKS to the clock tree circuit 175 according to the clock control signal CC, thereby stopping transmitting the clock signals CK2 and CK3 to the processor 110 and the memory 160. In operation S205, the bus controller circuit 140 stops sending access requests RQ to the processor 110 and the memory 160 according to the request signal SQ. With these operations, the clock controller circuit 120 ensures that in the first power-saving mode, the processor 110 and the memory 160 stop receiving access requests RQ and clock signals CK2 and CK3, thereby reducing overall dynamic power consumption.

FIG. 2B illustrates a flowchart illustrating the operations performed by the embedded system 100 when exiting the first power-saving mode according to some embodiments of the present disclosure. In operation S211, when the clock controller circuit 120 detects the interrupt signal S11 from another device or the request validation signal QV from the bus controller circuit 140, the clock controller circuit 120 clears the clock control signal CC and the memory control signal MC and starts counting for a predetermined duration. In response to the cleared clock control signal CC, the clock gating circuit 130 may begin providing the system clock signal CKS, thereby allowing the clock tree circuit 175 to start generating the clock signals CK2 and CK3 (e.g., operation S213). Similarly, in response to the cleared memory control signal MC, the memory 160 exits the power-saving mode and returns to operate in the normal mode. In operation S212, when the predetermined duration expires, the clock controller circuit 120 clears the request signal SQ and transmits the interrupt signal S12, allowing the memory 160 to exit the sleep mode. In operation S213, the clock gating circuit 130 provides the system clock signal CKS, allowing the clock tree circuit 175 to start providing the clock signals CK2 and CK3 to the processor 110 and the memory 160. In operation S214, the processor 110 starts operation according to the interrupt signal S12. In operation S215, the bus controller circuit 140 starts sending access requests RQ.

In some embodiments, when receiving the interrupt signal S11 and/or the request validation signal QV, the clock controller circuit 120 may clear the clock control signal CC, causing the clock gating circuit 130 to start providing the system clock signal CKS, which in turn enables the clock tree circuit 175 to provide the clock signals CK2 and CK3. In some embodiments, in order to ensure that the processor 110 and the memory 160 receive the stable clock signals CK2 and CK3, the clock controller circuit 120 may start counting for the predetermined duration when clearing the clock control signal CC and transmit the interrupt signal S12 to wake up the processor 110 and clear the request signal SQ after the predetermined duration expires, enabling the clock gating circuit 130 to start providing the system clock signal CKS. This allows the clock tree circuit 175 to start supplying the clock signals CK2 and CK3. As a result, the overall system reliability and compatibility are improved. In some embodiments, the predetermined duration has a time length sufficient for the clock signal CK2 (and/or CK3) to have a stable predetermined waveform after switching begins. In some embodiments, the clock controller circuit 120 may include several delay circuits to count the predetermined duration, but the present disclosure is not limited to thereto.

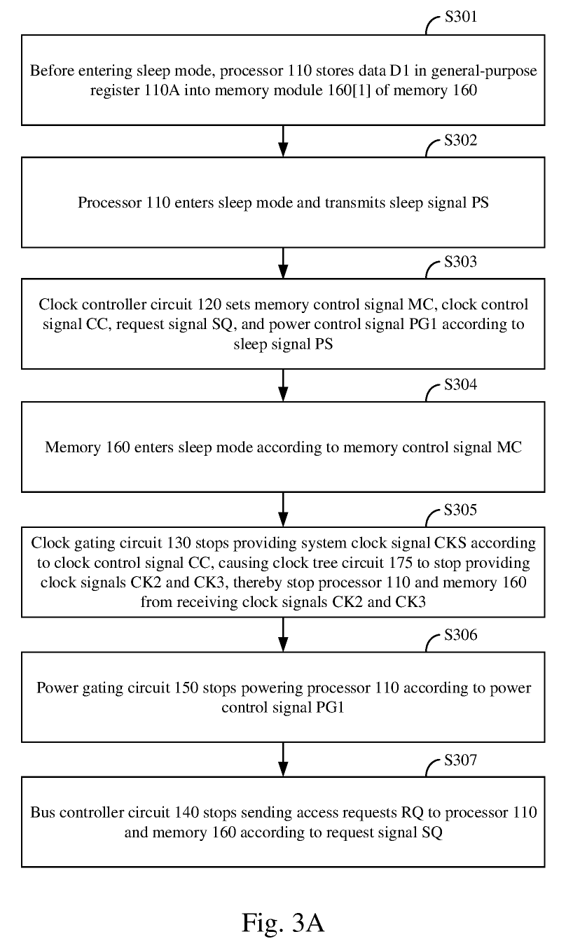

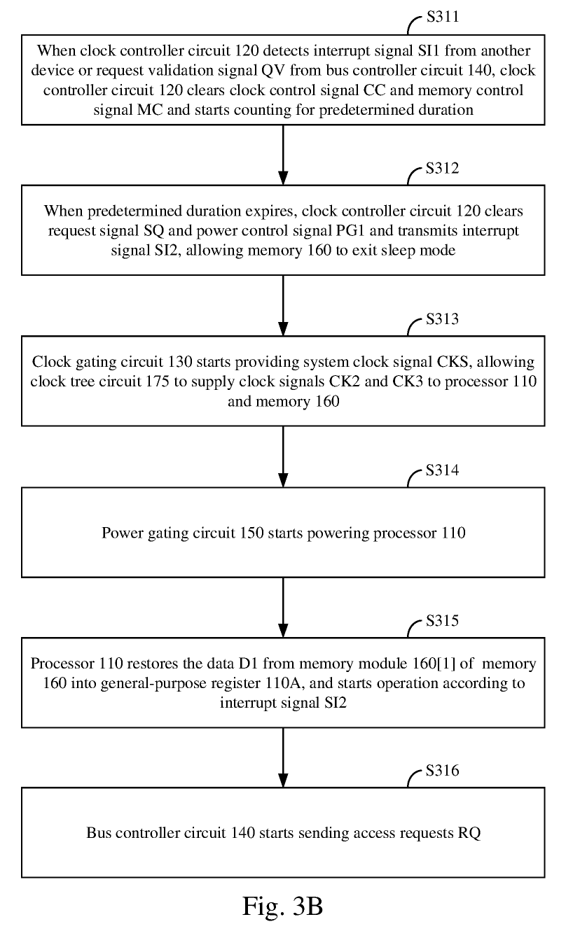

FIG. 3A illustrates a flowchart illustrating the operations performed by the embedded system 100 when entering the second power-saving mode according to some embodiments of the present disclosure. In operation S301, before entering sleep mode, the processor 110 stores data D1 in the general-purpose register 110A into the memory module 160[1] of the memory 160. For example, as shown in FIG. 1, the processor 110 includes a general-purpose register 110A, which stores data D1. In some embodiments, the data D1 may include intermediate results of various computations performed by the processor 110, memory addresses, functions, and/or control information, but the present disclosure is not limited thereto. In operation S302, the processor 110 enters the sleep mode and transmits the sleep signal PS. In operation S303, the clock controller circuit 120 sets the memory control signal MC, the clock control signal CC, the request signal SQ, and the power control signal PG1 according to the sleep signal PS. In operation S304, the memory 160 enters the sleep mode according to the memory control signal MC. In operation S305, the clock gating circuit 130 stops providing the system clock signal CKS according to the clock control signal CC, causing the clock tree circuit 175 to stop providing the clock signals CK2 and CK3, thereby stop the processor 110 and the memory 160 from receiving the clock signals CK2 and CK3. In operation S306, the power gating circuit 150 stops powering the processor 110 according to the power control signal PG1. In operation S307, the bus controller circuit 140 stops sending access requests RQ to the processor 110 and the memory 160 according to the request signal SQ. Compared with the first power-saving mode, the second power-saving mode allows the clock controller circuit 120 to further prevent the processor 110 from receiving the power voltage VCORE (e.g., operation S306), thereby achieving greater power savings.

FIG. 3B illustrates a flowchart illustrating the operations performed by the embedded system 100 when exiting the second power-saving mode according to some embodiments of the present disclosure. In operation S311, when the clock controller circuit 120 detects the interrupt signal S11 from another device or a request validation signal QV from the bus controller circuit 140, the clock controller circuit 120 clears the clock control signal CC and the memory control signal MC and starts counting for the predetermined duration. In operation S312, when the predetermined duration expires, the clock controller circuit 120 clears the request signal SQ and the power control signal PG1 and transmits the interrupt signal S12, allowing the memory 160 to exit the sleep mode. The power control signal PG1 is utilized to determine whether to power the processor 110. In operation S313, the clock gating circuit 130 starts providing the system clock signal CKS, allowing the clock tree circuit 175 to supply the clock signals CK2 and CK3 to the processor 110 and the memory 160. In operation S314, the power gating circuit 150 starts powering the processor 110. In operation S315, the processor 110 restores the data D1 from the memory module 160[1] of the memory 160 into the general-purpose register 110A, and starts operation according to the interrupt signal S12. In operation S316, the bus controller circuit 140 starts sending access requests RQ.

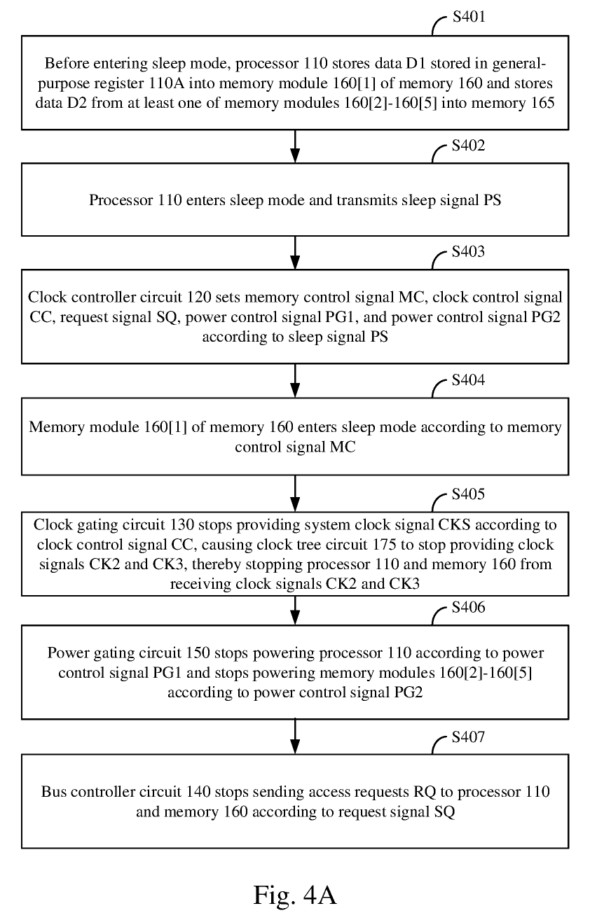

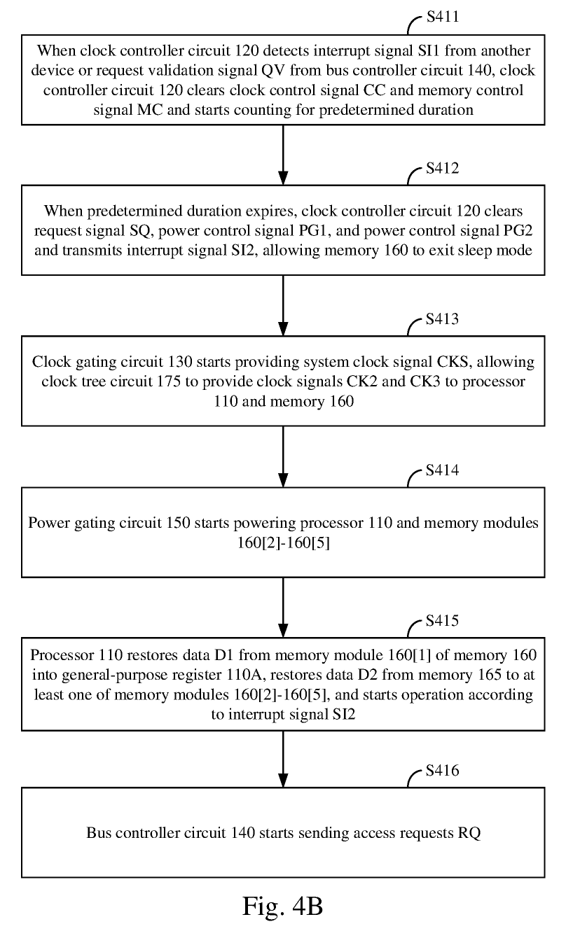

FIG. 4A illustrates a flowchart illustrating the operations performed by the embedded system 100 when entering the third power-saving mode according to some embodiments of the present disclosure. In operation S401, before entering the sleep mode, the processor 110 stores data D1 stored in the general-purpose register 110A into the memory module 160[1] of the memory 160 and stores data D2 from at least one of the memory modules 160[2]-160[5] into the memory 165. In this example, the memory 165 may be a non-volatile memory, which may be, as an example but not limited to, a flash memory. Thus, the memory may retain the data D2. In operation S402, the processor 110 enters the sleep mode and transmits the sleep signal PS. In operation S403, the clock controller circuit 120 sets the memory control signal MC, the clock control signal CC, the request signal SQ, the power control signal PG1, and the power control signal PG2 according to the sleep signal PS. In operation S404, the memory module 160[1] of the memory 160 enters the sleep mode according to the memory control signal MC. In operation S405, the clock gating circuit 130 stops providing the system clock signal CKS according to the clock control signal CC, causing the clock tree circuit 175 to stop providing the clock signals CK2 and CK3, thereby stopping the processor 110 and the memory 160 from receiving the clock signals CK2 and CK3. In operation S406, the power gating circuit 150 stops powering the processor 110 according to the power control signal PG1 and stops powering the memory modules 160[2]-160[5] according to the power control signal PG2. In operation S407, the bus controller circuit 140 stops sending the access requests RQ to the processor 110 and the memory 160 according to the request signal SQ. Compared with the second power-saving mode, the third power-saving mode further prevents certain memory modules in the memory 160 (e.g., memory modules 160[2]-160[5]) from receiving the power voltage VRAM, thereby achieving even greater power savings.

FIG. 4B illustrates a flowchart illustrating the operations performed by the embedded system 100 when exiting the third power-saving mode according to some embodiments of the present disclosure. In operation S411, when the clock controller circuit 120 detects the interrupt signal S11 from another device or a request validation signal QV from the bus controller circuit 140, the clock controller circuit 120 clears the clock control signal CC and the memory control signal MC and starts counting for the predetermined duration. In operation S412, when the predetermined duration expires, the clock controller circuit 120 clears the request signal SQ, the power control signal PG1, and the power control signal PG2 and transmits the interrupt signal S12, allowing the memory 160 to exit the sleep mode. The power control signals PG1 and PG2 are utilized to determine whether to power the processor 110 and multiple memory modules 160[2]-160[5]. In operation S413, the clock gating circuit 130 starts providing the system clock signal CKS, allowing the clock tree circuit 175 to provide the clock signals CK2 and CK3 to the processor 110 and the memory 160. In operation S414, the power gating circuit 150 starts powering the processor 110 and the memory modules 160[2]-160[5]. In operation S415, the processor 110 restores the data D1 from the memory module 160[1] of the memory 160 into the general-purpose register 110A, restores the data D2 from the memory 165 to the at least one of the memory modules 160[2]-160[5], and starts operation according to the interrupt signal S12. In operation S416, the bus controller circuit 140 starts sending access requests RQ.

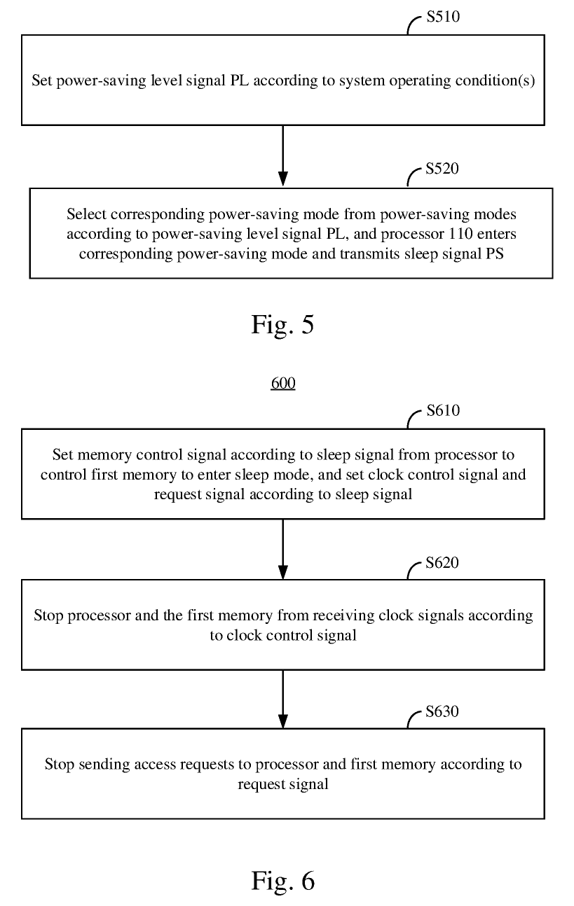

FIG. 5 illustrates a flowchart illustrating the operations performed by the processor 110 in selecting a power-saving mode according to some embodiments of the present disclosure. In operation S510, the power-saving level signal PL is set according to system operating condition(s). In operation S520, a corresponding power-saving mode is selected from power-saving modes according to the power-saving level signal PL, and the processor 110 enters the corresponding power-saving mode and transmits the sleep signal PS. For example, as previously mentioned, if the embedded system 100 is powered by an external power source (such as a charger), the processor 110 may set the power-saving level signal PL to a first value, enter the first power-saving mode, and perform corresponding operations (e.g., operation S201 in FIG. 2A). Alternatively, when the embedded system 100 is not connected to a charger and its battery level is not below a threshold, the processor 110 may set the power-saving level signal PL to a second value, enter the second power-saving mode, and perform corresponding operations (e.g., operations S301 and S302 in FIG. 3A). When the embedded system 100 is not connected to a charger and its battery level is below a threshold, the processor 110 may set the power-saving level signal PL to a third value, enter the third power-saving mode, and perform corresponding operations (e.g., operations S401 and S402 in FIG. 4A). Accordingly, the clock controller circuit 120 may control other circuits to enter the corresponding power-saving mode according to the power-saving level signal PL and the sleep signal PS. It should be understood that the examples with the first to third power-saving modes are given for illustrative purposes, but the present disclosure is not limited to thereto. In different embodiments, the power-saving modes in operation S520 may include at least two of the first to third power-saving modes.

FIG. 6 illustrates a flowchart illustrating a power-saving control method 600 according to some embodiments of the present disclosure. In some embodiments, the power-saving control method 600 may be applied to an embedded system (such as but not limited to the embedded system 100 in FIG. 1). In operation S610, a memory control signal is set according to a sleep signal from a processor to control a first memory to enter a sleep mode, and a clock control signal and a request signal are set according to the sleep signal. In operation S620, the processor and the first memory are stopped from receiving clock signals according to the clock control signal. In operation S630, access requests are stopped sending to the processor and the first memory according to the request signal.

The above operations can be understood with reference to the above embodiments, and thus the repetitious descriptions are not further given. Operations in FIG. 2A to FIG. 6 include exemplary operations, but the operations in FIG. 2A to FIG. 6 are not necessarily performed in the order described above. the operations in FIG. 2A to FIG. 6 may be added, replaced, changed order, and/or eliminated, or one or more operations in FIG. 2 to FIG. 4 may be executed simultaneously or partially simultaneously as appropriate, in accordance with the spirit and scope of various embodiments of the present disclosure.

As described above, the embedded system and power-saving control method provided by some embodiments of the present disclosure can further gate clock signals and power voltages when the processor operates in the sleep mode, thereby achieving greater power savings while maintaining compatibility with existing power-saving mechanisms.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely some embodiments of the present disclosure, without any intention to limit the scope of the present disclosure thereto. Various equivalent changes, alterations, or modifications according to the claims of present disclosure are all consequently viewed as being embraced by the scope of the present disclosure.

What is claimed is:

1. An embedded system, comprising:
a clock controller circuit configured to set a memory control signal according to a sleep signal from a processor to control a first memory to enter a sleep mode and to set a clock control signal and a request signal according to the sleep signal;
a clock gating circuit configured to stop transmitting a plurality of clock signals to the processor and the first memory according to the clock control signal; and
a bus controller circuit configured to stop sending an access request to the processor and the first memory according to the request signal.

2. The embedded system of claim 1, wherein when the clock controller circuit detects a first interrupt signal or receives a request validation signal from the bus controller circuit, the clock controller circuit is further configured to clear the clock control signal and the memory control signal and start counting for a predetermined duration, and when the predetermined duration expires, the clock controller circuit clears the request signal and transmits a second interrupt signal, allowing the first memory to exit the sleep mode, the clock gating circuit to start providing the plurality of clock signals to the processor and the first memory, the processor to start operation according to the second interrupt signal, and the bus controller circuit to start sending the access request.

3. The embedded system of claim 1, wherein the processor is further configured to store data from a general-purpose register in the processor into the first memory before the processor transmits the sleep signal.

4. The embedded system of claim 1, further comprising:
a power gating circuit configured to stop powering the processor according to a power control signal,
wherein the clock controller circuit is further configured to set the power control signal according to the sleep signal.

5. The embedded system of claim 4, wherein when the clock controller circuit detects a first interrupt signal or receives a request validation signal from the bus controller circuit, the clock controller circuit is further configured to clear the clock control signal and the memory control signal and start counting for a predetermined duration, and when the predetermined duration expires, the clock controller circuit clears the power control signal and the request signal and transmits a second interrupt signal, allowing the first memory to exit the sleep mode, the clock gating circuit to start providing the plurality of clock signals to the processor and the first memory, the power gating circuit to start powering the processor, the processor to restore data from the first memory to a general-purpose register and start operation according to the second interrupt signal, and the bus controller circuit to start sending the access request, and the power control signal is utilized to determine whether to power the processor.

6. The embedded system of claim 1, wherein the first memory comprises a first memory module and a second memory module, and the processor is configured to store first data from a general-purpose register in the processor into the first memory module and store second data from the second memory module into a second memory before the processor transmits the sleep signal.

7. The embedded system of claim 6, further comprising:
a power gating circuit configured to stop powering the processor and the second memory module according to a plurality of power control signals,
wherein the clock controller circuit is further configured to generate the plurality of power control signals according to the sleep signal.

8. The embedded system of claim 7, wherein when the clock controller circuit detects a first interrupt signal or receives a request validation signal from the bus controller circuit, the clock controller circuit is further configured to clear the clock control signal and the memory control signal and start counting for a predetermined duration, and clear the plurality of power control signals and the request signal and transmit a second interrupt signal when the predetermined duration expires, allowing the first memory to exit the sleep mode, the clock gating circuit to start providing the plurality of clock signals to the processor and the first memory, the power gating circuit to start powering the processor and the second memory module, and the processor to restore the first data from the first memory module to the general-purpose register, restore the second data from the second memory to the second memory module, and start operation according to the second interrupt signal, and the bus controller circuit to start sending the access request, and the plurality of power control signals are utilized to determine whether to power the processor and the second memory module.

9. The embedded system of claim 6, wherein the first memory module is powered without power gating, and the second memory module is powered with power gating.

10. The embedded system of claim 6, wherein the first memory is a volatile memory, and the second memory is a non-volatile memory.

11. The embedded system of claim 1, wherein the processor is configured to transmit the sleep signal when the processor enters the sleep mode.

12. A power-saving control method, comprising:
setting a memory control signal according to a sleep signal from a processor to control a first memory to enter a sleep mode and setting a clock control signal and a request signal according to the sleep signal;
stopping transmitting a plurality of clock signals to the processor and the first memory according to the clock control signal; and
stopping sending an access request to the processor and the first memory according to the request signal.

13. The power-saving control method of claim 12, further comprising:
clearing the clock control signal and the memory control signal to allow the first memory to exit the sleep mode, and starting counting for a predetermined duration when a first interrupt signal is detected or a request validation signal from a bus controller circuit is received; and
when the predetermined duration expires, clearing the request signal and transmitting a second interrupt signal to start providing the plurality of clock signals to the processor and the first memory, allowing the processor to start operation according to the second interrupt signal and start sending the access request.

14. The power-saving control method of claim 12, further comprising:
before the processor transmits the sleep signal, storing data from a general-purpose register in the processor into the first memory.

15. The power-saving control method of claim 12, further comprising:
setting a power control signal according to the sleep signal; and
stopping powering the processor according to the power control signal.

16. The power-saving control method of claim 12, further comprising:
clearing the clock control signal and the memory control signal to allow the first memory to exit the sleep mode and starting counting for a predetermined duration when a first interrupt signal is detected or a request validation signal from a bus controller circuit is received; and
when the predetermined duration expires, clearing a power control signal and the request signal and transmitting a second interrupt signal to start providing the plurality of clock signals to the processor and the first memory, start powering the processor, and start sending the access request,
wherein the power control signal is utilized to determine whether to power the processor, and the processor is further configured to restore data from the first memory to a general-purpose register in the processor and start operation according to the second interrupt signal.

17. The power-saving control method of claim 12, wherein the first memory comprises a first memory module and a second memory module, and the power-saving control method further comprises:
before the processor transmits the sleep signal, storing first data from a general-purpose register in the processor into the first memory module, and storing second data from the second memory module into a second memory.

18. The power-saving control method of claim 17, further comprising:
setting a plurality of power control signals according to the sleep signal; and
stopping powering the processor and the second memory module according to the plurality of power control signals.

19. The power-saving control method of claim 17, further comprising:
clearing the clock control signal and the memory control signal to allow the first memory to exit the sleep mode and starting counting a predetermined duration when a first interrupt signal is detected or a request validation signal from a bus controller circuit is received; and
when the predetermined duration expires, clearing a plurality of power control signals and the request signal and transmitting a second interrupt signal to start providing the plurality of clock signals to the processor and the first memory, start powering the processor and the second memory module, and start sending the access request,
wherein the plurality of power control signals are utilized to determine whether to power the processor and the second memory module, and the processor is further configured to restore the first data from the first memory module to the general-purpose register, restore the second data from the second memory to the second memory module, and start operation according to the second interrupt signal.

20. The power-saving control method of claim 17, wherein the first memory module is powered without power gating, and the second memory module is powered with power gating.
